(19) United States
(12) Patent Application Publication
(10) Pub. No.: US 2023/0273060 A1
(43) Pub. Date: Aug. 31, 2023

(54) METHOD FOR DISTRIBUTED DETERMINATION OF A FILL LEVEL OR LIMIT LEVEL

(71) Applicant: VEGA Grieshaber KG, Wolfach (DE)

(72) Inventors: Roland WELLE, Hausach (DE); Christian HOFERER, Offenburg (DE)

(73) Assignee: VEGA Grieshaber KG, Wolfach (DE)

(21) Appl. No.: 18/040,360

(22) PCT Filed: Aug. 3, 2020
(86) PCT No.: PCT/EP2020/071825

§ 371 Date: Feb. 2, 2023

(51) Int. Cl. G01F 23/284; G01F 23/80

(52) U.S. Cl. CPC G01F 23/284; G01F 23/804

(57) ABSTRACT

A method for distributed determination of a filling level or limit level of a filling material by means of a sensor is provided, the method including steps of: determining, by the sensor, characteristic values of significant reflection points of an echo curve; and transmitting, by the sensor, the characteristic values of significant reflection points to a server, the characteristic values being usable for determining the filling level or the limit level in a decision process. A sensor configured to perform the steps of the method, and a server configured to perform the steps of the method, are also provided.

### FIELD OF THE INVENTION

The invention relates to a method for determining a filling level or limit level of a filling material. In particular, the invention relates to a method for distributed determination of a filling level or limit level. Furthermore, the invention relates to a system, a use, a program element and a computer-readable medium.

### BACKGROUND

Measuring devices, in particular field devices with sensors for filling level or limit level determination, are used to determine a filling level or limit level of a product. Such measuring devices may, for example, comprise a radar sensor and/or other sensors. At least some of these measuring devices may communicate with a cloud and transmit the data determined in the sensor to it.

### SUMMARY

It is a task of the invention to provide a sensor, which has an economical operating mode. This task is solved by the subject-matter of the independent patent claims. Further embodiments of the invention result from the subclaims and the following description.

One aspect relates to a method for distributed determination of a filling level or limit level of a filling material by means of a sensor, comprising the steps:
d) determining, by the sensor, characteristic values of significant reflection points of the echo curve; and
e) transmitting, by the sensor, the characteristic values of significant reflection points to a server, the characteristic values being usable for determining the level in a decision process.

The method is classified as being for “distributed” determination of the filling level or limit level. In this context, “distributed” is understood to mean, in particular, a division of one or more steps and/or tasks of the method between a plurality of computers or computing systems, for example between a measuring device, field device and/or sensor on the one hand and a cloud or another type of server—for example also a mobile device such as a laptop or tablet—on the other hand. Alternatively or additionally, further computing systems may be involved in the method, and/or the logical units such as “measuring device etc.” or “server etc.” may be divided between several physical units. These measuring devices may be used, for example, to indicate a certain level of a filling material at a measuring point, e.g. in a container, i.e. to indicate whether a predefined upper, lower or other limit of the filling level in the container has been reached. The container may be a vessel or measuring tank of any shape. The container may also be a channel, for example a stream or river bed.

The determination of characteristic values of significant reflection points may be preceded by the transmission and/or reception of a measurement signal. The sensor for transmitting and/or receiving the measurement signal may, for example, have a high-frequency frontend, e.g. for radar waves, an ultrasonic frontend and/or a laser frontend. Furthermore, a calculation of an echo curve may be performed by the sensor. The calculation of the echo curve may be performed, for example, by converting the reflected and received measurement signal into digital sample points. A plurality of sample points may be determined, for example more than 100, more than 1000, more than 10000, for example 1024, 2048, 4096 sample points. Characteristic values of significant reflection points are determined therefrom by the sensor and/or the measuring device, for example distance values, position values and/or amplitude values and/or other values characterizing significant reflection points. Significant reflection points are considered to be those reflection points which may contribute to the determination of the level or which may be used for this purpose.

This specific usability may include predefined information and/or formats of the transmitted characteristic values. Significant reflection points may be represented, for example, in the form of local maxima and/or other values of the in an echo curve. In particular, the echo curve has a significantly lower number of significant reflection points than determined at digital sampling points. The type and number of identified significant reflection points may be determined by the sensor depending on the converted measurement signal. The determination of the significant reflection points may involve some form of data reduction of the converted measurement signal. This comes into play in particular when the sensor (and/or the measuring device, field device, etc.) transmits exclusively the characteristic values of the identified significant reflection points to the server (and/or the cloud, etc.). The characteristic values of significant reflection points are usable for determining the level in a decision process. The decision making process may be performed in the server, for example. Details and examples of the decision process are explained below.

Advantageously, it may be achieved, for example, to provide a sensor having a sparse operating mode, and in particular that not all of the data detected in the sensor is transmitted from the sensor or measuring device to the cloud or to the server. In particular, this may provide a significant data reduction of the data to be transmitted. This may be particularly advantageous if the transmission, the transmission channel and/or the transmission module has a limited bandwidth, for example due to legal and/or other regulations and/or because narrowband communication is used for transmission. This may, for example, contribute to a reduction in the power consumption of the sensor.

In addition, the method makes it possible to eliminate the need to parameterize the sensor or the measuring device. In many cases, this makes it possible to provide a “standard device” or a generic level measuring device for the determination of a filling level, limit level and/or other values, which may be used at a measuring point without further parameterization. Any “parameterization” or application-dependent parameterization that may be required may, for example, be relocated to the server and/or the cloud, where, in addition, higher computing power, a database—e.g. with data on this measuring device and/or its history —, a neural network and/or further facilities may be available. This “parameterization” may be carried out, for example, on the basis of the results of the decision-making process.

In one embodiment, only the characteristic values of significant reflection points are transmitted to the server in step e). This advantageously leads to a further reduction in the amount of data transmitted.

In some embodiments, the method comprises further steps:
a) Mounting of the sensor at a measuring point;
b) transmitting, through the sensor, a measurement signal; and
c) Receiving, by the sensor, the reflected measurement signal and calculating an echo curve.

Thereby, the mounting of the sensor at the measuring point may advantageously take place without prior parameterization, at least for some sensors. The emission of the measurement signal, the reception of the reflected measurement signal and the calculation of an echo curve by the sensor may, for example, be carried out in a manner as described above and/or below.

In one embodiment, the transmission of the characteristic values to the cloud may be radio-based. This may simplify installation and use of the measuring device.

In some embodiments, the sensor is implemented as a non-parameterized sensor. In this case, the sensor may transmit, for example, a “(spatial) location” and/or an amplitude of the reflected measurement signal, optionally additionally one or more adjacent amplitude maxima. For example, further data may also be transmitted for test purposes and/or cyclically. This is particularly advantageous if the transit time sensor is located in a closed housing and therefore no parameterization is possible on the customer side or user side. The closed housing may lead, for example, to robustness and/or insensitivity to chemical, mechanical and/or other influences on the sensor. The closed housing may also be designed, for example, to use the sensor in a potentially explosive environment.

Furthermore, the sensor or runtime sensor may be operated autonomously. In particular, sensors whose commissioning only takes place by means of a mounting and optionally an activation may be understood as autonomous. Such sensors may, for example, have an energy storage device so that an external power supply is not necessary. Furthermore, parameterization at the sensor itself may not be necessary.

In some embodiments, the transmission from the sensor or measuring device to the server is unidirectional. This may protect the device from hacker attacks, for example.

In some embodiments, the characteristic parameters comprise local amplitude maxima of the echo curve. The local amplitude maxima of the echo curve may be used, for example, to determine significant reflection locations. For example, the “location” and amplitude of the amplitude maxima may be determined and transmitted. The local amplitude maxima may have a lower amplitude than a global amplitude maximum. For example, the highest local amplitude maxima may be, for example, 10 dB, 20 dB, 30 dB away from the global maximum. In at least some cases, the local amplitude maxima may be determinable with quite little effort, for example, using characteristic values such as “location” and/or “amplitude”. Advantageously, this may contribute to a further reduction of the energy requirements of the measuring device.

In some embodiments, the characteristic parameters include only those local amplitude maxima of the echo curve that exceed a predefined amplitude threshold. The predefined amplitude threshold may be, for example, 10 dB, 20 dB, 30 dB, and/or some other value away from the global maximum. The amplitude threshold may, for example, depend on the “(spatial) location”; for example, the amplitude threshold may be chosen lower for a local amplitude maximum that is further away from the transmitting front end than for a spatially close location. The predefined amplitude threshold may also be adjustable, e.g. depending on previous measurements.

In some embodiments, values of a defined distance from the locations or positions of local amplitude maxima of the echo curve are determined as the locations, positions and/or distance values of significant reflection points. For example, “location” and amplitude of about 70% (or −3 dB) below the global amplitude maximum may be sent. This has been shown in a number of practical tests to be particularly meaningful for determining a filling level or limit level.

In some embodiments, only an excellent subset of the characteristic values of significant reflection points is transmitted to the server. The distinguished subset may be determined by one or more highest amplitude maxima and/or by exceeding a minimum spatial distance from a transmitter of the measurement signal. The distinguished subset may be a true subset, and in this way may further reduce the amount of data transmitted. For example, a pre-selection of significant reflection points—e.g., by position and amplitude—may be made. For example, if a plurality of highest amplitude maxima have been measured, the highest amplitude maxima may be selected. Advantageously, this may be done without losing the generic properties of the self-sufficient sensor, e.g. without having to perform any kind of parameterization of the sensor.

In addition to “location” and “amplitude”, other properties may be used as characteristic values of a reflection point. For example, a signal-to-noise ratio, a signal-to-noise ratio, a shape and/or form, a position of a beginning and/or end of the reflection point, a width of the reflection point and/or further values may be considered or used as characteristic parameter. The measuring device may be designed to “autonomously”—i.e., e.g., rule-based—recognize which characteristic features are relevant for transmitting (and possibly, for a server, usable for transforming into a level). For example, the measuring device may transmit only those characteristic features that are considered particularly relevant and/or necessary as basic information for a server to transform into a level value. For example, in the case of clear echo ratios, only a transmission of a spatial location of the amplitude maximum may suffice. In the case of less clear echo conditions, e.g. in the case of several reflection points, the amplitude of the reflection points and/or further characteristic features may be transmitted—e.g. in addition to the spatial location. It should be noted that the measuring device and the server each operate autonomously; however, they may be coordinated with each other in combination.

One aspect relates to a method for distributed determination of a filling level or limit level of a fill material using a server, comprising the steps of:
f) receiving, by the server, characteristic values of significant reflection points; and
g) transforming, by the server by means of the decision process and/or using parameter data, the characteristic values of significant reflection points into the level of the product and/or into a value representing the level of the product.

The characteristic values may, for example, have been generated and/or transmitted by a sensor. The server may be set up for receiving and for further processing, e.g. for transforming, the identified significant reflection points. Thereby, the characteristic values of the received significant reflection points may be transformed into the level and/or the filling height of the filling material or medium by means of the decision process and/or using parameter data. The parameter data and/or parameterization data may thereby include or influence the selection of the reflection point of the medium to be measured from the sum of all determining reflection points. This may include, for example, an addition of an individual parameterization stored specifically for this measuring point, of history information and/or of further information. The filling level and/or limit level determined in this way may then be output on an interface, a display, etc. and/or transferred to a memory area, a database, etc.

The decision process may include, for example, in the case of receiving characteristic values of a single significant reflection point, detecting an empty tank or an overfilled tank. This decision process may, for example, take into account a history of the filling level, e.g. whether a high or low filling level has been determined in the recent past. In another case where characteristic values of two (different) significant reflection points have been received, the decision process may conclude that one of the two different significant reflection points is a reflection point which correlates with a reflection at a product surface. In this regard, the decision process may include, for example, a heuristic and/or a statistic. The decision process may also include a trivial decision, for example, to use a transferred characteristic value of significant reflection sites directly; however, this is not part of the scope of protection. Further examples of the decision process are explained below, e.g. exemplified by a selection of reflection patterns.

In some embodiments, the method comprises further steps:
h) forming, by the server, history information of the characteristic values of the reflection points and/or the level by means of a tracking algorithm; and
i) applying, by the server, the history information to the received characteristic values of the reflection points.

The history information may have been collected for a specific sensor and/or formed from history information from a plurality of sensors. The history information may be used for post-processing or post-processing of the characteristic values of significant reflection points. For example, it may be used to check the plausibility of the fill levels or fill heights, in particular also in the case of incomplete measurement data, for example by interpolation of the known historical fill levels. Furthermore, slow changes, e.g. due to contamination, may be taken into account. Furthermore, customer inputs may be allowed and/or taken into account during post-processing in the cloud. Thus, an application and/or device-dependent parameterization of the received data of the unparameterized sensor may contribute to a further improvement of the measurement quality.

In some embodiments, the parameter data is connected to the sensor by the server, for example logically connected, for example by means of a database entry. For example, this type of connection may be applied to a serial number of the sensor, so that the data of each sensor undergoes, for example, a specifically adapted post-processing. Furthermore, this may be used to regulate access authorizations, for example, so that customer inputs are only permitted and/or taken into account for a group of sensors determined in this way.

In some embodiments, the parameter data or the application and/or device-dependent parameters include a tank height, a tank cross-section, a characteristic of the medium, and/or a selection of an application type. For example, such an application type may include a measurement in a storage tank, a measurement of a flow level, and/or other values. The property of the medium may comprise, for example, its specific permittivity and/or other characteristic values of the medium. These parameters may be made known to the cloud service, for example, during post-processing. This may contribute to the post-processing of the received data on the server using the application-dependent parameters available on the server side, e.g. in the context of transforming the characterizing characteristic values of significant reflection points into the level of the medium by means of parameter data.

In some embodiments, transforming the characteristic values of significant reflectance locations is performed considering time of day, weather data, logistics data, and/or learned patterns. Alternatively or additionally, the post-processing may consider external sources of information. For example, capturing the time of day may incorporate typical disturbances and/or temperatures. For example, the server may access weather data, such as for temperature, humidity, etc. This may be used, for example, to determine an accumulation with condensate. Logistics data may include, for example, times of a filling or emptying of a tank, so as to plausibilize a change in level based on scheduled filling or emptying times. Learned patterns may also be used, for example, to infer the filling level based on the characteristics of various constellations at transmitted reflection points.

In some embodiments, transforming the characteristic values of significant reflection points comprises adjusting the measured value and/or scaling the measured value. The adjustment of the measured value may comprise, for example, a filling level where about 0 m corresponds to a filling level or a filling level of 0%, and 1 m filling level corresponds to 100% filling level. The scaling may comprise, for example, that 0% filling level corresponds to 0 liters fill quantity, and 100% corresponds to, for example, 500 liters. The final numerical values resulting after an adjustment of the measured value and/or a scaling of the measured value may be understood as further examples of a value representing the filling level of the filling material.

In some embodiments, the method comprises further steps:
j) determining, by the server, a selected subset of the characteristic values of significant reflection points; and
k) transmitting, by the server, the selected subset of the characteristic values of significant reflection points to the sensor.

In this context, it may be provided that, after a decision has been made by the decision process, the selected subset is selected, for example, according to a “probability of correct decision” criterion. For example, in cases where a predefined probability is fallen short of, a refinement of the characteristic values at these significant reflection points may be useful and/or necessary. For this purpose, the server may transmit the selected subset to the sensor, for example. The selected subset to be transmitted may be designed—e.g., by specific information and/or formats of the selected subset—to be usable for further processing by the sensor.

In some embodiments, the method comprises further steps:
l) Receiving, by the sensor, the selected subset of characteristic values of significant reflection points;
m) refining, by the sensor, the selected subset of characteristic values of significant reflectance locations; and
n) transmitting, by the sensor, refined characteristic values of the selected subset of characteristic values of significant reflection points.

For example, for the selected subset of the characteristic values of a significant reflection point determined thereby, a measured value may be determined with increased precision by the computing unit of the sensor on the basis of the large quantity of points of a signal, for example an echo curve, stored in the sensor (at least for a short time) and available there. This measured value, which may comprise only a few bytes of useful data, for example, may then be transmitted—e.g. via a radio channel—to the server, where further steps such as linearization and scaling may be performed, and the resulting measured value may thereby be provided with improved precision.

One aspect relates to a sensor configured to perform the steps of the method as described above and/or below.

One aspect relates to a server configured to perform the steps of the method as described above and/or below.

One aspect relates to a system for distributed determination of a filling level or limit level of a filling material, the system comprising a sensor and a server arranged to perform the method steps as described above and/or below.

One aspect relates to a use of a system as described above and/or below for distributed determination of a filling level or limit level of a product.

One aspect relates to a program element which, when executed on a sensor and/or a server as described above and/or below, instructs the sensor and/or the server to perform the method as described above and/or below.

One aspect relates to a computer-readable medium on which the program element described herein is stored.

It should also be noted that the various embodiments may be combined.

For further clarification, the invention is described with reference to embodiments illustrated in the figures. These embodiments are to be understood as examples only and not as limitations.

### SHORT DESCRIPTION OF THE FIGURES

In doing so, it shows:

FIG. 1 schematically shows a measuring device according to one embodiment;

FIG. 2 schematically a system for the distributed determination of a filling level or limit level according to an embodiment;

FIGS. 3 to 6 schematically show a series of exemplary echo curves;

FIG. 7 flowchart showing a method according to one embodiment.

### DETAILED DESCRIPTION OF EMBODIMENTS

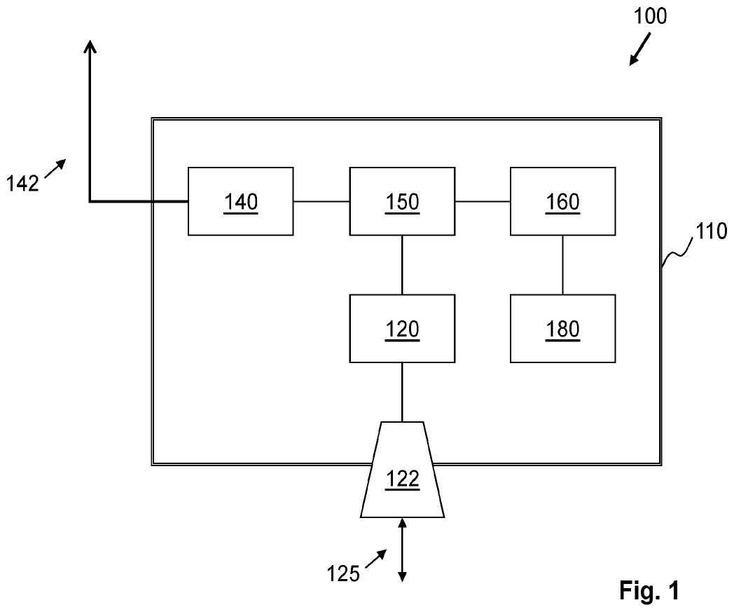

FIG. 1 schematically shows a measuring device 100 according to one embodiment. The measuring device 100 may comprise a high frequency front end, an ultrasonic front end and/or a laser front end. A high frequency front end, e.g. for radar waves, is schematically shown; however, this is only for clarification and is not to be considered as a limitation. The measuring device 100 may, for example, be designed as an autonomously operating radar level measuring device and/or comprise another of the aforementioned front ends.

The measuring device 100 may, for example, comprise a housing 110, in particular a hermetically sealed housing, which completely encloses the electronics and which may, for example, effectively prevent the ingress of dust or moisture. A battery or an accumulator 180 may be arranged in the housing 110, by means of which the complete sensor electronics may be supplied with energy. As an example of use, it may be assumed, for example, that the measuring device 100 is activated at predeterminable time intervals, for example once per day, by a controllable switch 160 releasing the power supply for a processor 150. The processor 150 then initializes and/or boots an operating system. Once initialization is complete, for example, a flow logic integrated in the processor 150 may control the acquisition of measurement data measured and provided, for example, by a measurement data determination unit 120. For this purpose, the processor first activates the measurement data determination unit 120, which, for example, generates a high-frequency signal, radiates the high-frequency signal via the measurement antenna 122—for example through a sensor wall—and receives the signals reflected by the filling material again, processes them and finally makes them available in digitized form to the processor 150 for further processing. The processor 150 may be implemented, for example, as a microcontroller or as a special part of a microcontroller. The processor 150 may, for example, determine from the reflected signals an echo curve and characteristic parameters of at least one reflection mapped in the echo curve or characteristic parameters of at least one significant reflection location mapped in the echo curve. For example, known and/or further developed methods, including the methods described herein, may be used to determine the echo curve.

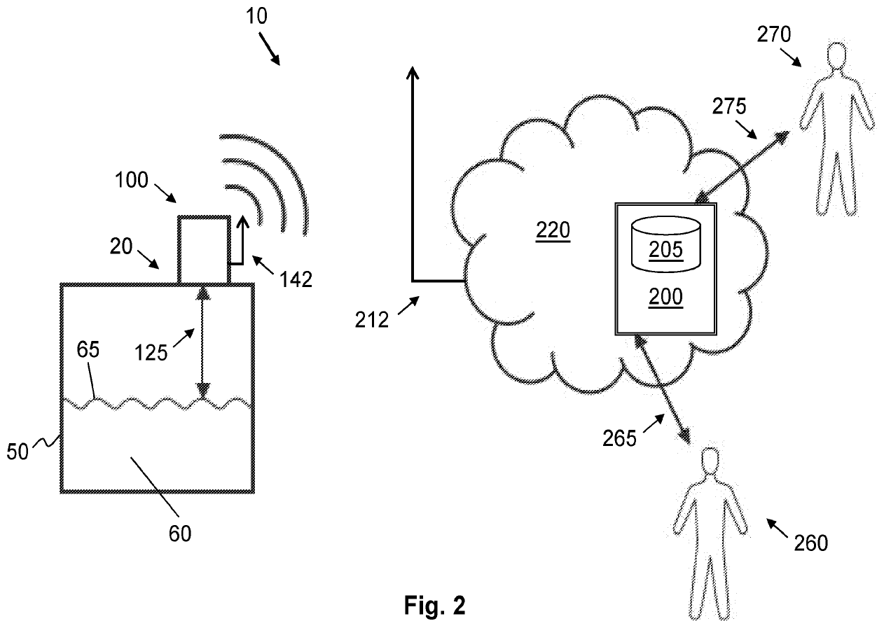

Sending the data may be done, for example, using a wireless communication device 140 via a communication antenna 142. In some cases, it may be necessary to activate the communication device 140 for each transmission. For this purpose, in some cases, for example, an additional switch (not shown) may be used and/or provided for powering the communication device 140. In particular, the transmitted data may comprise characteristic values of significant reflection points. The data may be sent, for example, to a higher-level cloud unit (see, for example, FIG. 2). For sending, in particular energy optimized wireless communication methods such as LoRa, LoRaWAN (Long Range Wide Area Network), Sigfox, NB-IoT (NarrowBand IoT) and/or other energy optimized protocols and/or low energy wide area networks may be used. A characteristic feature of at least some of these protocols is that—in order to preserve energy efficiency—only a few bytes of user data are supposed to be transmitted. After the characteristic values of significant reflection points have been transmitted, the transmission channel may be closed again in a timely manner, and the communication device 140 may be deactivated. The processor 150 may open the controllable switch 160 after completion of the measurement, which may cause the components 140, 150, 120, 122 to enter a low-power or energy-saving state. Further processing of the transmitted characteristic values, and in particular the determination and provision of a measured value, may be carried out in a cloud, for example.

In some embodiments, the measuring device 100 may—for example, for energy saving and/or cost reasons—have neither a display unit nor a control unit, so that a change of the sensor settings or a software update cannot be performed on site.

FIG. 2 schematically shows a system 10 for distributed determination of a filling level or limit level, in particular for distributed processing of sensor measurement data and provision of filling levels, according to one embodiment. A sensor unit or measuring device 100 is arranged on a container or tank 50, which emits a measurement signal 125 in the direction of a surface 65 of a medium 60 and receives the reflected measurement signal. The measuring device 100 converts the received measuring signal into a digital representation—for example into an echo curve—and thus performs a first part of a signal processing chain.

In the case of a radar level sensor that operates, for example, according to the FMCW principle, the converted signal may be, for example, a mixed intermediate frequency signal that is present in its digital representation as a so-called beat curve in the memory of the sensor unit. This beat curve may—e.g. in the case of precise level sensors—comprise several thousand sampling points. A transmission of the entire raw data, i.e. the sampling points and/or further data, to a cloud and the sole processing of the data on a cloud server may be disadvantageous, e.g. due to the enormous amount of data, in particular if the sensor unit 100 is an autonomous or self-sufficient or even battery-powered sensor. In this context, the transmission channel to the cloud may represent a bottleneck from an information point of view, in particular during a distributed computation within the overall system 10. If, for example, a radio-based transmission is used, this may be associated with a certain, sometimes very high, energy requirement, which may burden the energy storage of the sensor unit 100. It may therefore be advantageous for a self-sufficient sensor to reduce the amount of data transmitted. This may be done, for example, by means of the method described above and/or below.

With an FMCW system, for example, an FFT (Fast Fourier Transformation) may be performed after a digital windowing of the beat curve and the result may be logarithmized. This allows a data reduction to take place. However, the loss of information resulting from the data reduction may in many cases have no effect on the quality of the level measurement, and in particular this may not be dependent on other external factors such as user-specifiable, application-dependent parameters. The result of this static pre-processing of the signals with the accompanying initial reduction of the data volume is usually referred to as an echo curve. In a next step, characteristic values—e.g. position, amplitude, etc.—of individual reflection points are determined from the echo curve. A decision on a particular reflection point, whose physical origin is the surface 65 of the medium 60, cannot be reliably made in the sensor unit in at least some cases due to lack of information on the application and external circumstances. Therefore, in a next step, the extracted characteristic values of the reflection points may be transmitted—e.g. by means of narrowband radio such as LoRa, Sigfox, NB-IoT, CAT-M— to a cloud 220. The cloud 220 may comprise, for example, a server 200 and a database 205. The data transmission may involve other participants, such as receiving antennas and gateways. In many cases, the transmitted data has a size of only a few bytes; this may represent a significant reduction in data, compared to transmitting the entire echo curve. For example, a data reduction by a factor of 1000 and higher may be achieved when measured against the original samples. It should be noted that the transmitted data does not yet include any decisions with respect to the correct measurement value. This aspect may, for example, open up the possibility of dispensing a parameterization of the measurement device.

In the cloud 220, for example with the aid of further information, the determination of a filling level or limit level takes place, i.e. the actual decision as to which of the transmitted characteristic values represents a reflection of this measuring device 100 originating from the surface 65 of a medium 60. Based on the characteristic values of this reflection point, the measured value, e.g. the level, may be determined. Further steps, such as linearization and scaling, may also be performed in the cloud so that the level may be made available to the user 260 in the desired processed form to the outside world via a display, communication channel 265, etc.

Additionally, a second actor 270 may perform interventions in the cloud-implemented signal processing chain or configurations via a communication channel 275 without having to be directly present at the sensor unit on site.

In an alternative embodiment, it may be provided that, after a decision has been made on a reflection originating from the surface 65 of a medium 60, identifying characteristic values, for example characteristic values of the identified filling material reflection point, are transmitted back to the sensor unit via the radio channel. In the sensor unit, on the basis of the identifying characteristic value or characteristic values of the identified product reflection point (for example “echo 3”), a measured value may be determined with increased precision by the computing unit of the sensor on the basis of the large quantity of points of a signal, for example an echo curve, available there. This measured value—comprising a few bytes of user data—may again be transmitted back to the cloud via the radio channel, where further steps such as linearization and scaling may be performed, and the resulting measured value may be made available to the outside world.

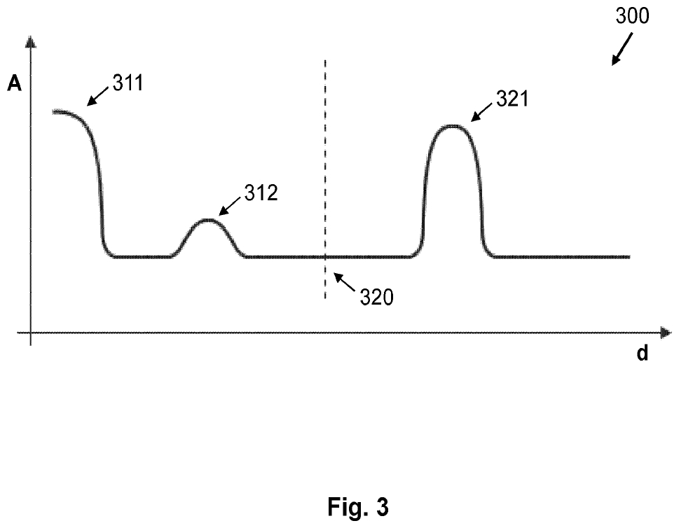

FIG. 3 schematically shows an echo curve 300 with two echoes. These may originate, for example, from a generic radar sensor which may be designed for distances of up to 30 m. Three reflections 311, 312 and 321 are visible. Reflection 311 may be rejected by the sensor or by the server because this reflection was measured too close to the antenna 122 (see FIG. 1). In one embodiment, the sensor unit may transmit only the characteristic values of the reflections 312 and 321, and in another embodiment, it may also transmit the characteristic value of the reflection 311. Since the application parameters describing the medium and the container height 320 are available in the cloud, a correct decision as to which of the two reflections originates from the surface of the medium may be made there. For example, considering the parameterized container height, the cloud service may also discard the reflection 321 because it is recognized that this reflection has no relevance to the level determination. For example, a history of the last fill levels may be used for this decision.

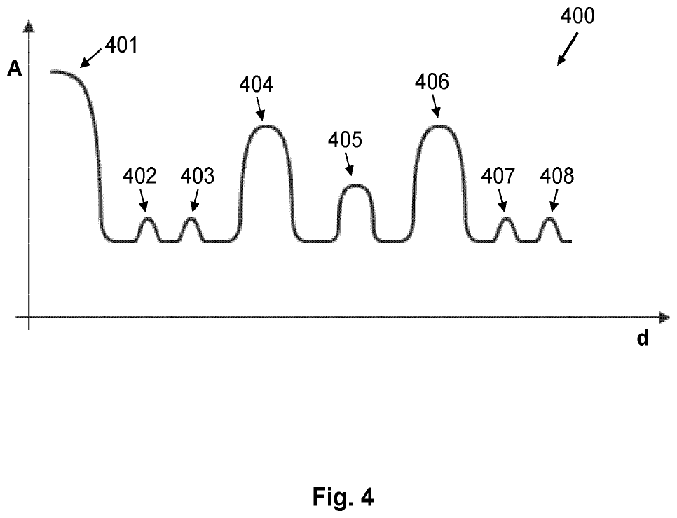

FIG. 4 schematically shows an echo curve 400 in which the sensor already performs a preselection. The echo curve 400 has eight reflections 401 to 408, which may originate from different reflection points, such as from the surface of the medium and from interferers. The first part of the signal processing chain not only determines the reflections and determines their characteristic parameters, but also performs a pre-selection on reflections and/or determination of significant reflection points in a data reduction step, without pruning the generic property of the sensor unit. Thus, only those reflections are discarded which—easily recognizable by the sensor—may in no way originate from a product surface. This selection may be made, for example, using predefined algorithms, some of which are known in the prior art, based on location and amplitude. In the example, only the reflections 404 and 406 show characteristics that may originate from a product surface due to the height of their amplitude. Consequently, in the subsequent steps, only the characteristic values of these echoes 404 and 406 are transferred to the cloud as significant reflection points.

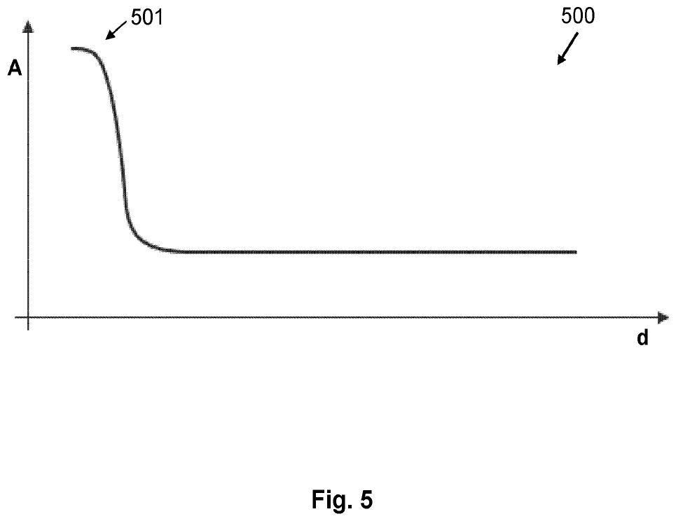

FIG. 5 schematically shows an echo curve 500, as it may occur with an empty tank as well as with an overfilled tank. Overfilled here means that the filling medium touches the antenna or tank wall below the sensor. On the basis of this echo curve 500, which has only a single reflection 501, no statement may be made as to the current filling level in the tank. The method may therefore provide for only sending information to the cloud service that no significant reflection has been detected. The cloud service or server may then decide from the trend of previous measurements whether the tank is empty or even overfilled. In addition, other data may be linked to the filling level decision algorithm. Logistics data such as the position of a container in conjunction with a recent filling may provide indications of the correct filling level. Historical data may also be used to determine where containers are usually filled and where they are emptied. Furthermore, information from a control system that initiated a filling and is made available to the cloud service may provide essential clues to the actual filling level in the tank. In this way, for example, a qualified statement about the actual filling level may advantageously be made from an echo curve, by means of which “actually” no statement about the filling level of the tank may be made, and in particular a distinction may be made between overfilling and empty tank in the cloud.

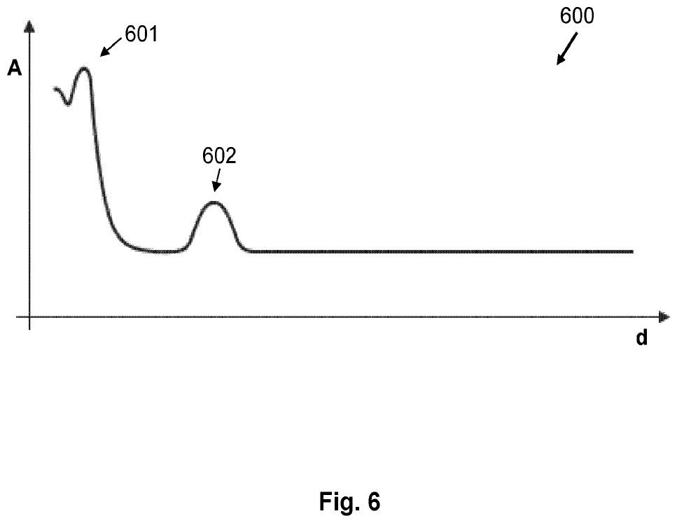

FIG. 6 schematically shows an echo curve 600 as it may be measured, for example, in the case of adhesion with condensate. The striking reflection in the near range 601 may be caused, for example, by condensate on the container ceiling or antenna. Condensate occurs over predominantly with temperature fluctuations that occur during the course of the day and in different weather conditions. A sensor that only wakes up briefly in cycles cannot record a temperature curve. A cloud service, however, has access to the times of day and weather data, and may thus conclude the correct filling level from the two reflections alone, here 602.

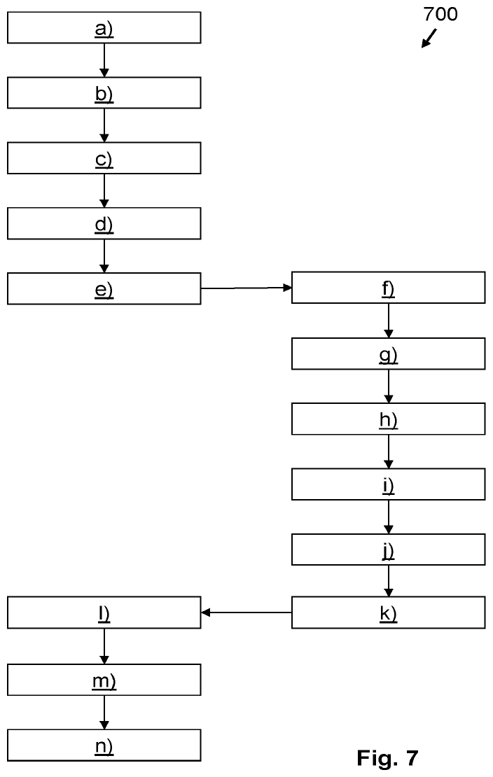

FIG. 7 shows a flowchart 700 showing a method for distributed determination of a filling level or limit level of a product, according to one embodiment. The method shown may have optional steps.

In step a) a sensor is mounted at a measuring point. In step b), a measurement signal is transmitted by the sensor. In step c), the reflected measurement signal is received by the sensor and an echo curve is calculated. In step d), characteristic values of significant reflection points of the echo curve are determined by the sensor. In a step e), only the characteristic values of significant reflection points are transmitted to a server by the sensor, wherein the characteristic values may be used to determine the filling level in a decision process. The further steps take place on the server and/or a cloud. In a step f), the characteristic values of significant reflection points are received, by the server. In a step g), the characteristic values of significant reflection points are transformed, by the server, into the filling level of the filling material by means of the decision process and/or using parameter data. In a step h), history information of the characteristic values of the reflection points and/or the filling level is formed by the server using a tracking algorithm. In a step i), the history information is applied to the received characteristic values of the reflection points.

In a step j), a selected subset of the characteristic values of significant reflection points is determined by the server. In step k), the server transmits the selected subset of characteristic values of significant reflection points to the sensor. In a step l), the sensor receives the selected subset of characteristic values of significant reflection points. In a step m), the sensor refines the selected subset of characteristic values of significant reflection points. In a step n), refined characteristic values of the selected subset of the characteristic values of significant reflection points are transmitted by the sensor.

### LIST OF REFERENCE SIGNS

10 system
20 measuring point
50 tank
60 fill material, medium
65 level, surface
100 measuring device, sensor unit
110 housing
120 measurement data determination unit
122 measuring antenna
125 measuring signal
140 communication equipment
142 communication antenna
150 processor
160 controllable switch
180 accumulator, battery
200 server
205 database
212 communication antenna
220 cloud
260 users
265 communication channel
270 second actor
275 communication channel
300 echo curve
311, 312 reflections
320 vessel height
321 reflection
400 echo curve
401-408 reflections
500 echo curve
501 reflection
600 echo curve
601, 602 reflection
700 flow diagram

1.-18. (canceled)

19. A method for distributed determination of a filling level or limit level of a filling material by means of a sensor, comprising the steps of:
determining, by the sensor, characteristic values of significant reflection points of an echo curve; and
transmitting, by the sensor, the characteristic values of significant reflection points to a server, the characteristic values being usable for determining the filling level or the limit level in a decision process.

20. The method according to claim 19, wherein in the transmitting step only the characteristic values of significant reflection points are transmitted to the server.

21. The method according to claim 19, further comprising the steps of:
mounting the sensor at a measuring point;
transmitting, through the sensor, a measurement signal; and
receiving, by the sensor, the reflected measurement signal and calculating an echo

22. The method according to claim 19, wherein the sensor is implemented as a non-parameterized sensor.

23. The method according to claim 19, wherein the transmission from the sensor to the server is unidirectional.

24. The method according to claim 19,
wherein the characteristic values comprise local amplitude maxima of the echo curve, and/or
wherein the characteristic values comprise only those local amplitude maxima of the echo curve that exceed a predefined amplitude threshold.

25. The method according to claim 19,
wherein only a distinguished subset of the characteristic values of significant reflection points is transmitted to the server, and
wherein the distinguished subset is determined by one or more highest amplitude maxima and/or by exceeding a minimum spatial distance from a transmitter of a measurement signal.

26. A method for distributed determination of a filling level or a limit level of a fill material by means of a server, comprising the steps of:
receiving, by the server, characteristic values of significant reflectance locations; and
transforming, by the server by means of a decision process and/or using parameter data, the characteristic values of significant reflection points into the filling level of the filling material and/or into a value representing the filling level of the filling material.

27. The method according to claim 26, further comprising the steps of:
forming, by the server, history information of the characteristic values of the reflection points and/or the level by means of a tracking algorithm; and
applying, by the server, the history information to the received characteristic values of the reflection sites.

28. The method according to claim 26,
wherein the parameter data comprises a container height, a container cross-section, a property of the medium, and/or a selection of an application type, and/or
wherein the transforming of the characteristic values of significant reflection points is performed taking into account time, weather data, logistic data, and/or learned patterns.

29. The method according to claim 19, further comprising the steps of:
determining, by the server, a selected subset of the characteristic values of significant reflection points; and
transmitting, by the server, the selected subset of characteristic values of significant reflection points to the sensor.

30. The method according to claim 19, further comprising the steps of:
receiving, by the sensor, the selected subset of characteristic values of significant reflection points;
refining, by the sensor, the selected subset of characteristic values of significant reflection points; and
transmitting, by the sensor, refined characteristic values of the selected subset of characteristic values of significant reflection points.

31. A sensor configured to perform the steps of the method according to claim 19.

32. The sensor according to claim 31, wherein the sensor is further configured to perform the steps of:
mounting the sensor at a measuring point, and
receiving, by the sensor, the reflected measurement signal and calculating an echo curve.

33. The sensor according to claim 31, wherein the sensor is further configured to perform the steps of:
determining, by the server, a selected subset of the characteristic values of significant reflection points, and
transmitting, by the server, the selected subset of characteristic values of significant reflection points to the sensor.

34. A server configured to perform the steps of the method according to claim 26.

35. The server according to claim 34, wherein the server is further configured to perform the steps of:
forming, by the server, history information of the characteristic values of the reflection points and/or the level by means of a tracking algorithm, and
applying, by the server, the history information to the received characteristic values of the reflection sites

36. The server according to claim 34, wherein the server is further configured to perform the steps of:
receiving, by the sensor, the selected subset of characteristic values of significant reflection points,
refining, by the sensor, the selected subset of characteristic values of significant reflection points, and
transmitting, by the sensor, refined characteristic values of the selected subset of characteristic values of significant reflection points.

37. A system for distributed determination of a filling level or a limit level of a fill material, the system comprising:
a sensor according to claim 31; and
a server configured to perform the steps of:
receiving, by the server, characteristic values of significant reflectance locations; and
transforming, by the server by means of a decision process and/or using parameter data, the characteristic values of significant reflection points into the filling level of the filling material and/or into a value representing the filling level of the filling material.

38. A nontransitory computer-readable storage medium comprising computer program instructions stored therein, which when executed on a sensor, instructs the sensor to perform the steps of the method according to claim 19.
